(19) United States
(12) Patent Application Publication
(10) Pub. No.: US 2006/0071765 A1
(43) Pub. Date: Apr. 6, 2006

(54) Tire pressure monitoring device

(75) Inventor: Hank Lin, Nan-Tou Hsien (TW)

Correspondence Address: OSTROLENK FABER GERB & SOFFEN, 1180 AVENUE OF THE AMERICAS, NEW YORK, NY, 100368403, US

(73) Assignee: Universal Scientific Industrial Co., Ltd.

(21) Appl. No.: 11/022,440

(22) Filed: Dec. 23, 2004

(30) Foreign Application Priority Data
Sep. 30, 2004 (TW) 093215523

(51) Int. Cl. B60C 23/02

(52) U.S. Cl. 340/442

(57) ABSTRACT

A tire pressure monitoring device, which is disposed in a pneumatic tire and is mounted on a rim of a vehicle, includes a casing, a sensor circuit, a set of electrical contacts, and a cover. The casing defines a battery compartment that receives a battery, and is formed with an opening to permit access in the battery compartment. The sensor circuit is mounted in the casing, and is operable so as to detect a pressure of the pneumatic tire, and so as to generate a signal that corresponds to the detected pressure of the pneumatic tire. The electrical contacts are mounted in the battery compartment of the casing, and are coupled to the sensor circuit and the battery. The cover is connected detachably to the casing so as to cover and uncover selectively the opening of the casing.

### CROSS-REFERENCE TO RELATED APPLICATION

This application claims priority of Taiwanese application no. 093215523, filed on Sep. 30, 2004.

### BACKGROUND OF THE INVENTION

1. Field of the Invention

The invention relates to a tire pressure monitoring device, more particularly to a wireless tire pressure monitoring device.

2. Description of the Related Art

FIGS. 1 and 2 illustrate a conventional tire pressure monitoring device 10 that is disposed in a pneumatic tire 21 and that is wrapped around a rim 22 of a vehicle (not shown) with the use of a strap 24.

As illustrated in FIG. 1, the conventional tire pressure monitoring device 10 includes a casing 11, a sensor circuit 12, and a set of electrical contacts 14.

The sensor circuit 12 is mounted in the casing 12, and is operable so as to detect a pressure of the pneumatic tire 21 and so as to generate a signal that corresponds to the detected pressure of the pneumatic tire 21.

The electrical contacts 14 are connected electrically to the sensor circuit 12 and a battery 13.

During assembly, the sensor circuit 12 is first mounted in the casing 11, and then followed by the battery 13. Finally, the casing 11 is filled up with a sealing compound (not shown) through a hole (not shown) in the casing 11.

The conventional tire pressure monitoring device 10 is disadvantageous in that when the battery 13 has run out of battery life, the sealing compound has to be removed first before the battery 13 can be replaced. This causes inconvenience on the part of a user. Alternatively, the whole conventional tire pressure monitoring device 10 is replaced with a new one. However, this is economically unsound and environmentally unfriendly.

### SUMMARY OF THE INVENTION

Therefore, the object of the present invention is to provide a tire pressure monitoring device that is capable of overcoming the aforesaid drawbacks of the prior art.

According to the present invention, a tire pressure monitoring device, which is for a pneumatic tire of a vehicle, comprises a casing, a sensor circuit, a set of electrical contacts, and a cover. The casing defines a battery compartment that is adapted to receive a battery, and is formed with an opening to permit access to the battery compartment. The sensor circuit is mounted in the casing, and is operable so as to detect a pressure of the pneumatic tire, and so as to generate a signal that corresponds to the detected pressure of the pneumatic tire. The electrical contacts are mounted in the battery compartment of the casing, are coupled to the sensor circuit, and are coupled to the battery when the battery is disposed in the battery compartment. The cover is coupled to the casing so as to cover and uncover selectively the opening of the casing.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary sectional view of a conventional tire pressure monitoring device;

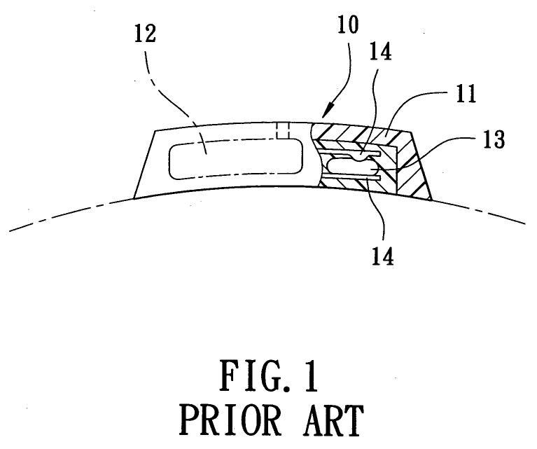

FIG. 2 is a perspective view of the conventional tire pressure monitoring device in a state of use;

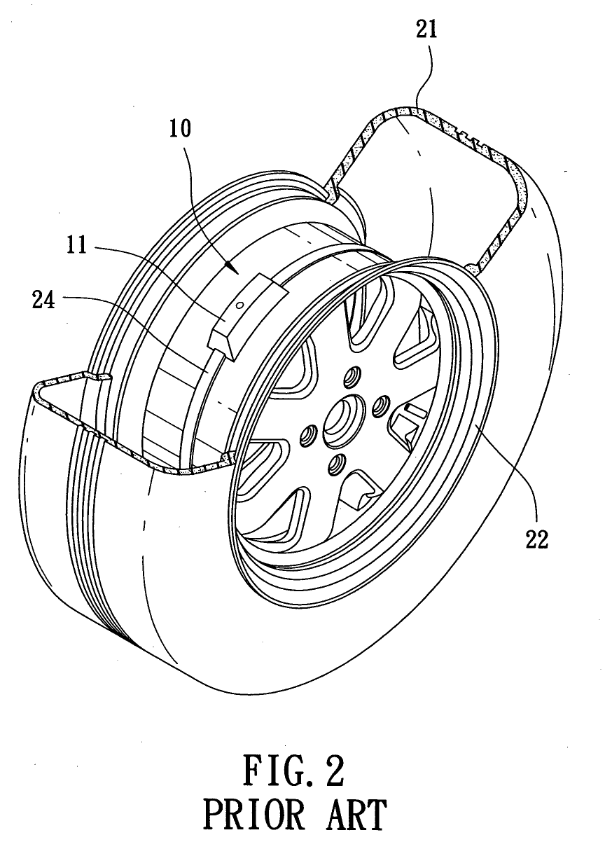

FIG. 3 is an exploded perspective view of the first preferred embodiment of a tire pressure monitoring device according to the present invention;

FIG. 4 is an exploded perspective view of the first preferred embodiment illustrating a state where a cover covers an opening of a casing;

FIG. 5 is perspective view of illustrating the first preferred embodiment in a state of use;

FIG. 6 is an exploded perspective view of the second preferred embodiment of a tire pressure monitoring device according to the present invention; and

FIG. 7 is a perspective view of the second preferred embodiment illustrating a state where a cover covers an opening of a casing.

### DETAILED DESCRIPTION OF THE PREFERRED EMBODIMENTS

Before the present invention is described in greater detail, it should be noted that like elements are denoted by the same reference numerals throughout the disclosure.

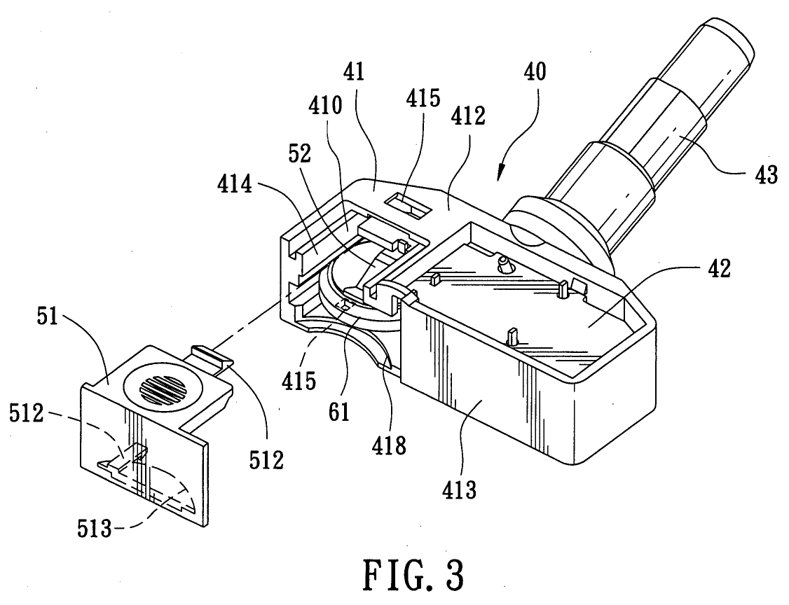

Referring to FIGS. 3 to 5, the first preferred embodiment of a tire pressure monitoring device 40 is shown to include a casing 41, a sensor circuit 42, a set of electrical contacts 52, and a cover 51.

The casing 41 defines a battery compartment 414 that serves to receive a battery 61, and is formed with an opening 410 to permit access to the battery compartment 414. In this embodiment, the casing 41 includes a first casing wall 412, a second casing wall 413 that is transverse to and that extends from the first casing wall 412, and a third casing wall 411 that is opposite to the first casing wall 412. The second casing wall 413 interconnects the first and second casing walls 412, 413. The opening 410 of the casing 41 is generally L-shaped as a result of being formed through the first and second casing walls 412, 413.

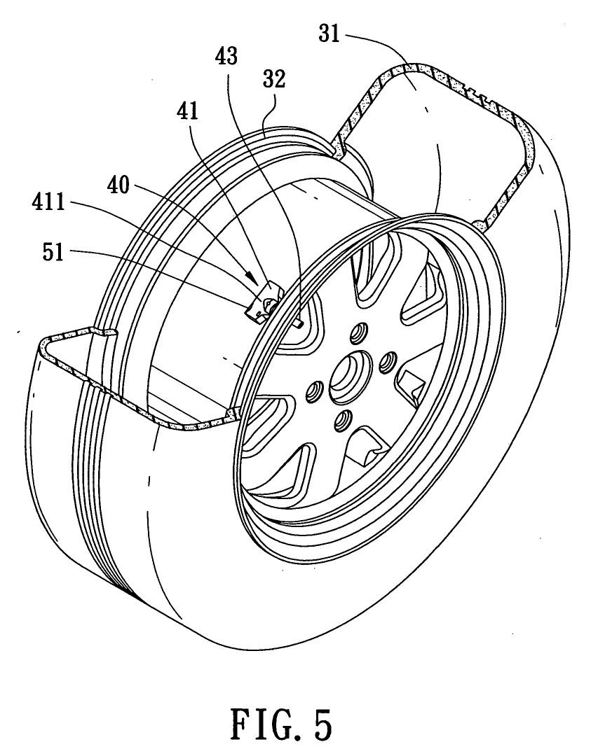

The tire pressure monitoring device 40 further includes an air valve 43 connected removably to the casing 41. The junction of the air valve 43 and the casing 41 is formed with a hole 416. As shown in FIG. 5, the tire pressure monitoring device 40 of this invention is disposed in a pneumatic tire 31 of a vehicle (not shown) such that the air valve 43 extends outwardly through a rim 32 of the vehicle. The pneumatic tire 31 is inflated (and deflated) through the hole 416 via the air valve 43, in a known manner.

The sensor circuit 42 is mounted in the casing 41, and is operable so as to detect a pressure of the pneumatic tire 31, and so as to generate a signal that corresponds to the detected pressure of the pneumatic tire 31.

It is noted that the casing 41 is formed with an aperture 417 that is registered with the sensor circuit 42. The sensor circuit 42 detects the pressure of the pneumatic tire 31 through the aperture 417 in the casing 41.

The electrical contacts 52 are mounted in the battery compartment 414 of the casing 41, are coupled to the sensor circuit 42, and are coupled to the battery 61 when the battery 61 is disposed in the battery compartment 414. The battery 61 functions as a power source for the operation of the sensor circuit 42.

The cover 51 is connected detachably to the casing 41 so as to cover and uncover selectively the opening 410 of the casing 41. In this embodiment, the cover 51 includes a pair of transverse legs to result in a generally L-shaped configuration to thereby correspond to the shape of the opening 410.

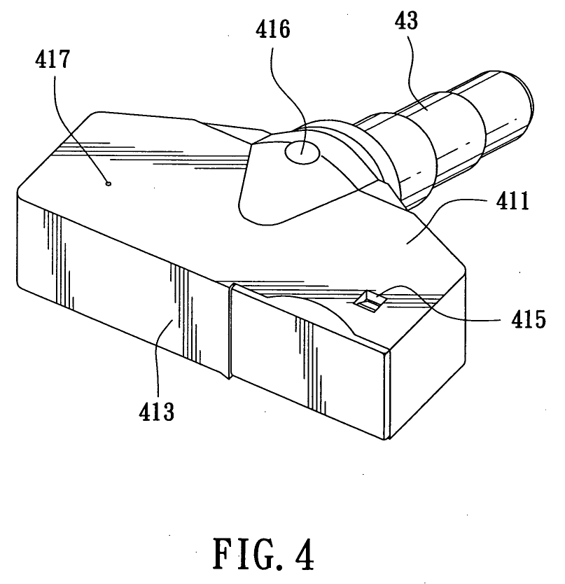

The tire pressure monitoring device 40 further includes a fastening unit. The fastening unit serves to fasten the cover 51 to the casing 41. In this embodiment, the fastening unit includes a pair of fastening grooves 415, each of which is formed in a respective one of the first and third casing walls 412, 411, and a pair of hook fasteners 512, each of which is formed on a respective one of the legs of the cover 51. Each of the hook fasteners 512 engages a respective one of the fastening grooves 415 when the cover 5 covers the opening 410 of the casing 41, as best shown in FIG. 4.

The tire pressure monitoring device 40 further includes a guiding unit. The guiding unit serves to facilitate fastening of the cover 51 to the casing 41. In this embodiment, the guiding unit includes an arcuate recess 418 that is formed in the third casing wall 411, and an arcuate tongue 513 that is formed on the cover 51. The arcuate tongue 513 extends into the recess 418 when the cover 51 covers the opening 410 of the casing 41.

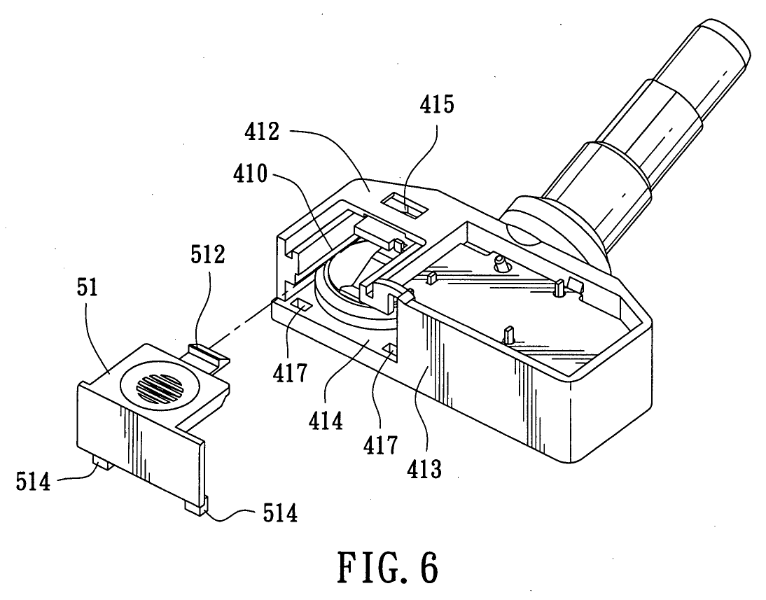

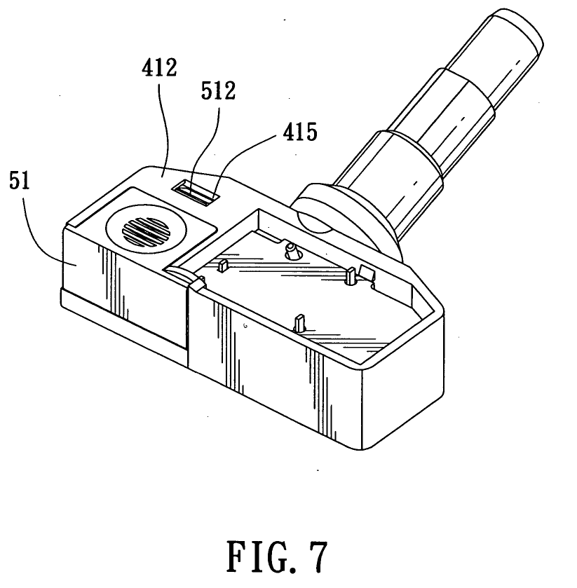

FIGS. 6 and 7 illustrate the second preferred embodiment of a tire pressure monitoring device 40. When compared to the previous embodiment, the fastening unit includes only one fastening groove 415 that is formed in the first casing wall 412, and only one hook fastener 512 that is formed on one leg of the cover 51. The hook fastener 512 engages the fastening groove 415 when the cover 51 covers the opening 410 of the casing 41, as best shown in FIG. 7. Moreover, the guiding unit includes a pair of guide holes 417, each of which is formed in the third casing wall 411, and a pair of guide protrusions 514, each of which is formed on the other one of the legs of the cover 51. Each of the guide protrusions 514 extends into a respective one of the holes 417 when the cover 51 covers the opening of the casing 41

It has thus been shown that the tire pressure monitoring device 40 of this invention includes a casing 41 that defines a battery compartment 414 and that is formed with an opening 410 to permit access in the battery compartment 414, a sensor circuit 42 mounted in the casing 41, a set of electrical contacts 52 mounted in the battery compartment 414 and coupled to the sensor circuit 42, and a cover 51 connected detachably to the casing 41 so as to cover and uncover selectively the opening 410 of the casing 41. The construction as such permits convenient replacement of a battery 61 disposed in the battery compartment 414.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A tire pressure monitoring device for a pneumatic tire of a vehicle, said tire pressure monitoring device comprising:
a casing defining a battery compartment adapted to receive a battery, and formed with an opening to permit access in said battery compartment;
a sensor circuit mounted in said casing, and operable so as to detect a pressure of the pneumatic tire, and so as to generate a signal that corresponds to the detected pressure of the pneumatic tire;
a set of electrical contacts mounted in said battery compartment of said casing, coupled to said sensor circuit, and adapted to be coupled to the battery when the battery is disposed in said battery compartment; and
a cover coupled to said casing so as to cover and uncover selectively said opening of said casing.

2. The tire pressure monitoring device as claimed in claim 1, wherein said cover is connected detachably to said casing.

3. The tire pressure monitoring device as claimed in claim 2, wherein said casing includes a first casing wall, and a second casing wall transverse to and extending from said first casing wall, said opening being generally L-shaped as a result of being formed through said first and second casing walls.

4. The tire pressure monitoring device as claimed in claim 3, wherein said casing further includes a third casing wall that is opposite to the first casing wall, said second casing wall interconnecting said first and second casing walls, said tire pressure monitoring device further comprising a fastening unit for fastening said cover to said casing, said fastening unit including
a pair of fastening grooves, each of which is formed in said first and third casing walls, and
a pair of hook fasteners formed on said cover, each of said hook fasteners engaging a respective one of said fastening grooves when said cover covers said opening of said casing.

5. The tire pressure monitoring device as claimed in claim 3, further comprising a fastening unit for fastening said cover to said casing, said fastening unit including
a fastening groove formed in said first casing wall, and
a hook fastener formed on said cover, said hook fastener engaging said fastening groove when said cover covers said opening of said casing.
